(19) United States
(12) Patent Application Publication
(10) Pub. No.: US 2012/0123038 A1
(43) Pub. Date: May 17, 2012

(54) PERCHLORATE SOLUTION IMPROVED IN SAFETY, AND A METHOD FOR HEAT-STABILIZING CHLORINE-CONTAINING RESIN COMPOSITIONS

(75) Inventors: Kenji Yoshino, Saitama (JP); Yoshiyuki Miyaki, Saitama (JP)

(73) Assignee: AKISHIMA CHEMICAL INDUSTRIES CO., LTD., Chiyoda-ku, Tokyo (JP)

(21) Appl. No.: 13/320,573

(22) PCT Filed: May 17, 2010
(86) PCT No.: PCT/JP2010/058686

§ 371 Date: Jan. 27, 2012

(30) Foreign Application Priority Data
May 15, 2009 (JP) 2009-118736

(51) Int. Cl. C08K 5/06; C08K 5/053

(52) U.S. Cl. 524/377; 106/499; 524/388

(57) ABSTRACT

To improve the handlability and safety of a perchlorate solution used as a stabilizer for chlorine-containing resins.

This invention provides a perchlorate solution of improved handlability and safety and a method for heat-stabilizing chlorine-containing resin compositions by adding (a) 0.004 to 10 parts by weight of a perchlorate solution containing 1 to 60% by weight of perchlorate, 5 to 50% by weight of water-soluble organic solvent and 20 to 94% by weight of water, and (b) 0.001 to 10 parts by weight of at least one silicate compound represented by the general formula (I) to 100 parts by weight of a chlorine-containing resin:

M(O)a nSiO₂mH₂O (I)

in which M is at least one metal selected from alkaline earth metals and aluminum, a is 1 when M is an alkaline earth metal and 3/2 where M is aluminum, n is from 1 to 5, and m is any positive integer.

### TECHNICAL FIELD

The invention relates to a method for improving processability or handlability and safety of a perchlorate solution as a stabilizer aid for chlorine-containing resins such as PVC.

The invention relates also to a use of a perchlorate solution with a stabilizer for chlorine-containing resins, to improve handlability and safety of the stabilizer.

The invention relates further to a method for heat-stabilizing chlorine-containing resin compositions.

### BACKGROUND ART

Chlorine-containing resins such as polyvinylchloride (PVC) have a variety of excellent properties and are used in wide applications. However, they have such disadvantage that they degrade due to dehydrochlorination when they are subjected to heat-moulding techniques, so that the resulting moulded articles are coloured and hence the product value is spoiled.

To improve the heat-stability of the chlorine-containing resins, a variety of stabilizers has been added to the chlorine-containing resins. There are several types of stabilizers including a lead-based system, an organo tin system and a metal soap-based system.

Recently, compositions containing the chlorine-containing resin such as PVC are used widely as a material for moulding interior decorative parts of automobiles. In particular, their uses are developing to covering materials for crash-pad, arm-rest, head-rest, console, meter cover, door rim and the like. In such application as covering materials for interior decorative parts of vehicles, it is usual practice to form a layer of polyurethane foam by adhesion or injection on a rear side of a layer made of a composition containing the chlorine-containing resin so as to improve the rebound elasticity and feeling of the interior decorative parts. Powder rotation moulding technique or powder-slush moulding technique also are used recently to mould the vehicle interior decorative parts.

In case of the vehicle interior decorative parts, they are requested to have such properties or performance that they can withstand satisfactorily severe conditions of exposure to a temperatures from 70° C. to 140° C. for longer time duration which depends on intended applications. Under such high temperature condition for a long time, the composite material comprising a chlorine-containing resin composition layer and a polyurethane layer bonded to the chlorine-containing resin composition layer by adhesion or injection will be coloured or physically deteriorated, so that the quality performance and the product value of the vehicle interior decorative parts are seriously spoiled. In fact, it is thought that residual amine compounds and cyanide compounds produced by heat-degradation of the polyurethane foam may migrate into the chlorine-containing resin composition layer, resulting in that the heat-degradation of the chlorine-containing resin composition layer is promoted.

To overcome the above technical problems, it have been proposed to add as stabilizer a combination of an organic metal salt compound bonded to an organic group (metal soap) with a solution of perchlorate dissolved in an organic solvent or with an aqueous perchlorate solution, to the chlorine-containing resin composition (see following Patent Documents No. 1 to No.6).

Patent Documents No. 1: JP-B1-57-57056

Patent Documents No. 2: JP-B1-57-47925

Patent Documents No. 3: JP-B1-57-47926

Patent Documents No. 4: JP-B1-57-47927

Patent Documents No. 6: JP-B1-63-462

Patent Documents No. 7: JP-U1-58-122951

However, when organic solvents are used in quantity in the stabilizer, they evaporate inside the vehicle resulting in problems of misting, stink and health of passengers. On the other hand, when an aqueous solution of perchlorate is used, crystals of perchlorate are formed inside pipe lines in the factory caused by evaporation of water from the aqueous perchlorate solution, so that there is a danger of explosion or fire caused by friction or shock of the perchlorate crystals.

Therefore, there is a need to provide a method of use of perchlorate with improved handlability and safety without spoiling the effect of perchlorates.

### DISCLOSURE OF INVENTION

### Technical Problems

An object of this invention is to improve the handlability and safety of perchlorate solutions used as a stabilizer for a chlorine-containing resin, by using a mixture of a water-soluble organic solvent having a high boiling point and water to prepare a solution of perchlorate.

### Technical Solution

This invention provides a solution of perchlorate for a stabilizer of chlorine-containing resins, comprising from 1 to 60% by weight of perchlorate, from 5 to 50% by weight of water-soluble organic solvent and from 20 to 94% by weight of water

### Advantageous Effect

By using the perchlorate solution according to this invention improved in handlability and safety, handling property and safety during production of chlorine-containing resin compositions including perchlorate can be improved. The method of heat-stabilizing chlorine-containing resin compositions according to this invention is effective to the production of vinyl chloride-based resin compositions by powder-moulding technique which are superior in heat-stability, heat-ageing and coloration.

### BEST MODE FOR CARRYING OUT THE INVENTION

The water-soluble organic solvent have preferably a boiling point higher than 150° C. and most preferably higher than 200° C. If a solvent having a boiling point lower than 150° C. is used, the effect of suppressing the crystallization of perchlorate will be unsatisfactory.

Examples of the water-soluble organic solvents include ethylene glycol, ethylene glycol mono-butyl ether, ethylene glycol mono-isoamyl ether, ethylene glycol mono-phenyl ether, ethylene glycol mono-benzyl ether, ethylene glycol mono-hexyl ether, diethyleneglycol, diethylene glycol mono-methyl ether, diethyleneglycol mono-butyl ether, diethylene glycol acetate, triethylene glycol, triethylene glycol mono-methylether, triethylene glycol mono-ethyl ether, triethyleneglycol mono-butyl ether, tetramethylene glycol, polyethylene glycol, propylene glycol, propylene glycol mono-butyl ether, dipropylene glycol, dipropylene glycol mono-methyl ether, dipropylene glycol mono-ethylether, tripropylene glycol, tripropylene glycol mono-methyl ether, 1,4-butanediol, 1,5-pentanediol, hexylene glycol, octylene glycol, glycerine, glycerine mono-acetate, glycerine di-acetate and glycerine mono-butylate.

These solvents may be used individually in this invention or a mixture of a plurality of types may be used.

The solution of perchlorate for a stabilizer of chlorine-containing resins according to the present invention is prepared by using following mixture (total is 100% by weight):

from 1 to 60% by weight of perchlorate,

from 5 to 50% by weight of water-soluble organic solvent and

from 20 to 94% by weight of water.

The solution of perchlorate can be used together with other stabilizer and/or stabilizer aids. An amount of the perchlorate solution according to the present invention is generally in a range of 0.01 to 10 parts by weight, preferably 0.05 to 5 parts by weight to 100 parts by weight of the chlorine-containing resin.

As other stabilizers which can be used in this invention may be organic metal salts starting with the metal phenolates and metal carboxylates of barium/zincsystem and calcium/zinc system, phenolic or sulphur-based antioxidants, organic phosphite ester compounds, ultraviolet absorbers, hindered amine-based photo-stabilizers, early-colouration inhibitors, organo-tin compounds and epoxy compounds.

The perchlorate used in this invention may be lithium, sodium, potassium, strontium, barium, zinc, aluminum and ammonium salts of perchloric. These may be anhydrous or hydrated salts and they may be used individually or in the form of mixtures.

When the perchlorates is used as stabilizer for a chlorine-containing resin composition, this is achieved by adding, per 100 parts by weight of the chlorine-containing resin, (a) from 0.004 to 10 parts by weight of the perchlorate solution containing from 1 to 60% by weight of perchlorate, from 5 to 50% by weight of water-soluble organic solvent and from 20 to 94% by weight of water, and (b) from 0.001 to 10 parts by weight of at least one silicate compound represented by the general formula (I):

M(O)a nSiO₂mH₂O (I)

in which M is at least one metal selected from alkaline earth metals and aluminum, a is 1 when M is an alkaline earth metal and 3/2 where M is aluminum, n is from 1 to 5, and m is any positive integer.

In this invention, the stabilization of the chlorine-containing resin composition can be realized more effectively by adding further from 0.05 to 10 parts by weight of hydrotalcite represented by the general formula (II):

M₍₁₋ₙ₎Alₓ(OH)₂(Aⁿ⁻_{x/n}) mH₂O (II)

in which M represents Mg and/or Zn, Aⁿ⁻ represents n-valent anion of CO₃²⁻ and/or ClO₄⁻, x is 0<x<0.5 and m is within the range 0≦m<3.

There are natural and synthetic forms of the abovementioned hydrotalcite compounds and both can be used in this invention.

Furthermore, those where the surface has been covered with a higher fatty acid such as stearic acid or oleic acid, a metal salt of a higher fatty acid, organic sulphonic acid metal salts such as the alkali metal salts of dodecylbenzene sulphonic acid, higher fatty acid esters, higher fatty acid amides, waxes or perchloric acid and the like can also be used.

The metals of the abovementioned organic metal salts may be sodium, potassium, lithium, magnesium, calcium, barium, zinc and aluminum.

The organic acid residual group may be that of a carboxylic acid, phenol or alkyl phenol such as those indicated below.

The carboxylic acids are saturated or unsaturated aliphatic carboxylic acids which have from 1 to 22 carbon atoms, cyclic or hetero cyclic carboxylic acids which have from 7 to 16 carbon atoms and hydroxy acids or alkoxy acids which have from 2 to 10 carbon atoms, and actual examples include formic acid, acetic acid, propionic acid, caprylic acid, octylic acid, 2-ethylhexanoic acid, neodecanoic acid, isodecanoic acid, lauric acid, stearic acid, myristic acid, palmitic acid, behenic acid, epoxidized stearic acid, isostearic acid, 12-hydroxystearic acid, 12-ketostearic acid, oleic acid, ricinolic acid, linolic acid, linoleic acid, glycolic acid, lactic acid, hydroacrylic acid, a -oxyacetic acid, glycerolic acid, malic acid, tartaric acid, citric acid, thioglycolic acid, mercaptopropionic acid, lauryl mercapto propionic acid, benzoic acid, p-tertbutyl benzoic acid, toluic acid, dimethyl benzoic acid, aminobenzoic acid, salicylic acid, aminoacetic acid, glutamic acid, oxalic acid, succinic acid, adipic acid, phthalic acid, maleic acid and thiodipropionic acid.

Examples of the phenols and alkyl phenols include phenol, nonyl phenol, dodecyl phenol, tertbutyl phenol, octylphenol, isoamyl phenol and cresol,.

These metal salts of carboxylic acids and metal salts of alkyl phenols may be acid salts or neutral salts, or they may be basic salts, carbonates or per-basic salts.

Furthermore, the amount in which these organic metal salts are added is from 0.1 to 10 parts by weight, and preferably from 0.2 to 5 parts by weight per 100 parts by weight of chlorine-containing resin. One of these metal salts, or a mixture of two or more types, can be used.

The abovementioned organo-tin compound may be for example dimethyl tin oxide, dibutyl tinoxide, dioctyl tin oxide, dimethyl tin sulphide, dibutyl tin sulphide, dioctyl tin sulphide, dibutyl tindilaurate, dibutyl tin distearate, dioctyl tindioleate, dioctyl tin dilaurate, dioctyl tindistearate, dioctyl tin bis(oleylmalate), dibutyl tin(stearylmalate), dibutyl tin malate polymer, dioctyl tin malate polymer, dioctyl tin bis(butylmalate), dibutyl tin β-mercaptopropionate, dioctyl tin β-mercaptopropionate, dibutyl tin mercapto acetate, monobutyl tin tris(2-ethylhexylmercaptoacetate), dibutyl tin bis(2-ethylhexylmercaptoacetate), monooctyl tin tris(2-ethylhexylmercaptoacetate), dibutyltin(iso-octylmercaptoacetate), dioctyl tin bis(isooctylmercaptoacetate), dioctyl tin bis(2-ethylhexylmercaptoacetate), dimethyl tin bis(isooctylmercaptopropionate), mono-butyl tin tris(iso-octylmercaptopropionate) and mono-octyl tin tris(iso-octylmercaptopropionate).

An amount in which these organo-tin compounds are added is from 0.01 to 10 parts by weight, and preferably from0.05 to 5 parts by weight per 100 parts by weight of chlorine-containing resin.

The abovementioned early-colouration inhibitors may be β-diketone compounds and sulpholane compounds.

The β-diketone compounds is, for example, dehydroacetic acid, cyclohexane-1,3-dione, 2-benzoylcyclopentanone, 2-acetylcyclohexanone, 2-benzoylcyclo hexanone, acetylstearoylmethane, benzoylacetone, palmitoyl benzoylmethane, stearoyl benzoylmethane, dibenzoylmethane, tribenzoylmethane, 4-methoxybenzoylbenzoyl methane, bis(4-methoxybenzoylmethane), 4-chlorobenzoyl-benzoylmethane, benzoyltrifluoro acetone, palmitoyltetralone, stearoyltetralone and benzoyltetralone.

The abovementioned β-diketone compounds may be metal complex salts, and the metal from which the complex salt is formed is sodium, calcium and barium orzinc.

An amount of these early-colouration inhibitors added is from 0.0005 to 10 parts by weight, and preferably from 0.001 to 5 parts by weight per 100 parts by weight of chlorine-containing resin. One or a mixture of two or more types of these early-colouration inhibitors can be used.

The abovementioned organic phosphite ester compounds are typified by trialkyl phosphites, triaryl phosphites, alkylaryl phosphites, bisphenol A phosphite, polyhydric alcohol phosphites and acidphosphites where one or more of the organic esterresidual groups has been replaced with a hydrogen atom, and examples of such phosphite compounds include triphenyl phosphite, tri-iso-octyl phosphite, triisodecyl phosphite, tri-isododecyl phosphite, triisotridecyl thiophosphite, diphenyl iso-octylphosphite, diphenyl isodecyl phosphite, diphenyltridecyl phosphite, di-isodecyl pentaerythritoldiphosphite, tetraphenyl dipropylene glycoldiphosphite, poly(dipropylene glycol) phenyl phosphite,trilauryl thiophosphite, distearyl pentaerythritoldiphosphite, tri-2,4-di-t-butylphenyl phosphite, 2,4di-t-butylphenyl di-isodecyl phosphite, tributoxyethylphosphite, 4,4′-isopropylidene diphenylalkyl (C12 to C15)diphosphite, and pentakis(dipropylene glycol)triphosphite, 4,4′-butylenebis(3-methyl-6-t-butyl-di-tridecylphosphite).

Furthermore, the acid phosphites where one or two of the organic residual groups in the abovementioned phosphite ester compounds have been replaced with a hydrogen atom are also effective, and examples of these include diphenyl acid phosphite, monophenyl acidphosphite, di-iso-octyl acid phosphite, monoiso-octylacid phosphite, di-tridecyl acid phosphite, dibenzylacid phosphite, dinonylphenyl acid phosphite and the like.

Furthermore, the abovementioned organic phosphateester compounds, such as nonylphenyl polyoxyethylene (5-55) phosphate, tridecylpolyoxyethylene (4-10) phosphate and the like can be used as processing aids. Moreover, metal adducts of the organic phosphateesters, for example the magnesium, calcium, barium orzinc salt of a mono-/di-(mixed)iso-octylphosphate, the magnesium, calcium, barium or zinc salt of mono-/di(mixed)isotridecyl phosphate and the like can be used respectively as thermal stabilization aids.

Furthermore, the acid phosphates where one or two of the organic residual groups in the abovementioned organic phosphate esters have been replaced with a hydrogen atom are also effective, and examples include butyl acid phosphate, butoxyethyl acid phosphate, 2ethylhexyl acid phosphate and stearyl acid phosphate. Furthermore there are also the metal salts, for example magnesium, calcium, barium or zinc salts of these acid phosphates.

The abovementioned antioxidants are hindered phenols, for example alkylphenols, alkylated phenolesters, alkylene and alkylidene bisphenols, polyalkylated phenol esters, and examples of these include butylated hydroxyanisole, 4-hydroxymethyl-2,6di-t-butylphenol, 4,4′-dihydroxy-2,2′-diphenylpropane, 2,2′-methylenebis(4-methyl-6-t-butylphenol), 4,4′-thiobis(6-t-butyl-3-methylphenol) and tetrakis [methylene-3(3′,5′-di-t-butyl-4′-hydroxyphenyl)propionato]methane.

There are also dilauryl thiopropionic acid esters, distearylthiopropionic acid esters and the like, for example, as sulphur-containing alkanoic acid alkylesters.

The abovementioned epoxy compounds are epoxidized unsaturated oils and fats, epoxidized unsaturatedaliphatic acid esters, epoxycyclohexane derivatives orepichlorohydrin derivatives, and examples include epoxidized soybean oil, epoxidized castor oil, epoxidized linseed oil, epoxidized safflower oil, epoxidized linseed oil fatty acid butyl ester, epoxidized butyl, iso-octyl, 2-ethylhexyl alkyl esters of stearic acid, and metal salts with calcium, zinc and the like, 3-(2-xenoxy)-1,2epoxypropane, epoxyhexahydrophthalic acid di-2ethylhexyl ester, epoxypolybutadiene, bisphenol A diglycidyl ether and the like.

Other stabilizer aid may be polyhydric alcohols, such as mono-and dipentaerythritol, mannitol and sorbitol and there are the ester compounds of carboxylic acids, amino acids or rosin with these polyhydric alcohols, such as pentaerythritol stearate, pentaerythritol adipate, pentaerythritol pyrrolidone carboxylate, pentaerythritol glutamate, wood rosin pentaerythritol, pentaerythritol maleic anhydride wood rosin ester and wood rosin glycerol ester. Furthermore, there are benzotriazole-based compounds such as 1,2,3-benzotriazole, tolyltriazole and the 10 like, thiazole compounds such as 2-mercaptobenzothiazole and the like, ester compounds of β-aminocrotonic acid with 1,3-or 1,4-butanediol, 1,2-dipropylene glycol, thiodiethylene glycol, lauryl alcohol and the like, as well as tris(2-hydroxyethyl) isocyanate and tris(mercaptoethyl)isocyanurate compounds which are nitrogen-containing compounds.

The materials which are used as the abovementioned ultraviolet absorbers are typified by the benzotriazole and benzophenone based materials, and, for example, there are benzotriazole compounds such as 2-(5-methyl2-hydroxyphenyl)benzotriazole, 2-(3,5-di-t-butyl-2hydroxypheny)-5-chlorobenzotriazole, and 2-(3,5-di-t-amyl 2-hydroxyphenyl)benzotriazole, and 2,5 dimethylsuccinate 1-(2-hydroxyethyl)-4-hydroxy-2,2,6,6tetramethylpiperidine condensates as benzotriazolebased ultraviolet absorbers. There are, for example,2,4-dihydroxybenzophenone, 2-hydroxy-4-methoxy benzophenone, 2,2′-dihydroxy-4-methoxybenzophenone, 2,2′dihydroxy-4,4′-dimethoxybenzo phenone and 2-hydroxy-4-noctoxybenzophenone as benzophenone based ultraviolet absorbers.

The substances which can be used as the abovementioned photo-stabilizers are, for example, hindered amine compounds such as poly[{6-(1,1,3,3-tetramethylbutyl)amino-1,3,5-triazin2,4-diyl}{(2,2,6,6-tetramethyl-4-piperidyl)amino}hexamethylene{(2,2,6,6-tetramethyl-4-piperidyl)imino }].

Examples of the chlorine-containing resins with which the products of this invention can be used include polyvinyl chloride, chlorinated polyvinylchloride, vinyl chloride/vinyl acetate copolymers, vinyl chloride/ethylene copolymers, vinyl chloride/propylene copolymers, vinyl chloride/styrenecopolymers, vinyl chloride/isobutylene copolymers, vinyl chloride/vinylidene copolymers, vinyl chloride/styrene/maleic anhydride tricopolymers, vinyl chloride/alkyl, cycloalkyl or aryl maleimide copolymers, vinylchloride/styrene/acrylonitrile copolymers, vinylchloride/butadiene copolymers, vinyl chloride/isoprene copolymers, vinyl chloride/chlorinated propylenecopolymers, vinyl chloride/vinylidene chloride/vinylacetate tricopolymers, vinyl chloride/acrylic acidester copolymers, vinyl chloride/maleic acid ester copolymers, vinyl chloride/methacrylic acid ester copolymers, vinyl chloride/acrylonitrile copolymers, vinyl chloride/urethane copolymers, polyvinylidenechloride, chlorinated polyethylene and chlorinated polypropylene. No particular limitation is imposed upon the form of the resin or on the method by which it has been polymerized or produced.

In this invention plasticizers, anti-static agents, anti-misting agents, metal deactivators such as anti-rust agents and the like, fungicides, antibacterial agents, plate-out inhibitors such as low molecular weight acrylic acid ester oligomers mould release agents, viscosity reducing agents, surfactants, fluorescent whiteners, foaming agents, acrylic-based cell controlling agents, processing aids, lubricants, inorganic salts or inorganic metal compounds, and pigments, fillers such as calciumcarbonate, clay, flame retarders, surface treatment agents, cross-linking agents, reinforcing agents can be used appropriately, as required and according to the intended purpose.

Examples of the abovementioned plasticizers include phthalate-based plasticizers such as di-2ethylhexyl phthalate, dibutyl phthalate, di-isodecylphthalate, di-mixed alkyl (C9-11) phthalate, diheptylphthalate, di-isononyl phthalate and the like, adipate based plasticizers such as di-2-ethylhexyl adipate, diisononyl adipate, di-isobutyl adipate and di-isodecyl adipate, trimellitate-based plasticizers such as tri-2-ethylhexyl trimellitate, tri-n-octyltrimellitate, tri-isodecyl trimellitate, tributyltrimellitate and the like, sebacate-based plasticizers such as di-2-ethylhexyl sebacate, dibutyl sebacate, as well as phosphate-based plasticizers, polyester-based plasticizers, chlorinated paraffin-based plasticizers, pyromellitate-based plasticizers and epoxy-based plasticizers.

The abovementioned inorganic salts or inorganic metal compounds have, for example, the metal sodium, potassium, magnesium, calcium, barium, zinc, aluminum or tin for the metal, and there are oxides, hydroxides, silicates, borates, sulphates, perchlorates, phosphites, phosphates, basic carbonates and basic phosphates of these metals.

These compounds may be complex salts and they may be anhydrous or hydrates which have water of crystallization and, moreover, they may be in the form of mixtures. Furthermore they may also be complex compounds with polyhydric alcohols.

Typical examples of these compounds include the calcium-containing hydroxides which can be represented by (III), calcium oxide, magnesium oxide, zinc oxide, silicon oxide, aluminum oxide, calcium hydroxide, magnesium hydroxide, barium hydroxide, aluminum hydroxide, sodium silicate, calcium silicate, zinc silicate, aluminum silicate, potassium aluminum silicate, sodium borate, potassium borate, aluminum borate, aluminum borate, aluminum sulphate octadecahydrate, aluminum sodium sulphate dodeca-hydrate, sodium phosphate, sodium pyrophosphate, magnesium phosphate, calcium phosphate, calcium orthophosphate, zinc orthophosphate, sodium substituted A-type zeolite, calcium substituted A-type zeolite, magnesium substituted A-type zeolite, wollastonites and tobermorites.

Ca₍₁₋ₓ₎Mₓ(OH)₂ (III)

in which M represents Mg or Al, and x is within a range 0.005<x<0.5.

### EXAMPLES

Now, the invention is described in more detail on the basis of the illustrative examples indicated below. Of course the invention is not limited at all by these illustrative examples.

### Example 1

### Preparation

### Example 1-1

Triethylene glycol mono-methyl ether (boiling point of 249° C.) (10 g) was mixed with 66.7 g of a 60% sodium perchlorate aqueous solution and then 23.3 g of water were admixed to prepare a 40% sodiumperchlorate solution.

### Example 1-2

Polyethylene glycol 200 (boiling point of above 250° C.) (10 g) was mixed with 66.7 g of a 60% sodiumperchlorate aqueous solution and then a further 23.3 g of water were admixed to prepare a 40% sodiumperchlorate solution.

### Example 1-3

Glycerine (boiling point of 290° C.) (10 g) was mixed with 66.7 g of a 60% sodium perchlorate aqueoussolution and then a further 23.3 g of water were admixed to prepare a 40% sodium perchlorate solution.

### Example 1-4

Glycerine (boiling point of 290° C.) (20 g) was mixed with 66.7 g of a 60% sodium perchlorate aqueoussolution and then a further 13.3 g of water were admixed to prepare a 40% sodium perchlorate solution.

The stabilizer components prepared in the aforementioned Examples (10.0 g) were each weighed out in a Petri dish (of diameter about 60 mm) and left to stand in the open state at room temperature for 10 days and the state of evaporation of water component and precipitation of crystals was observed.

### Evaluation Criteria:

For the loss in weight by evaporation the proportion (%) by which the weight had fallen in 10 days, and for the precipitation of crystals the day within 10 days on which precipitation was observed.

### Comparative Example 1-1

Water (33.3 g) was mixed with 66.7 g of a 60% sodium perchlorate aqueous solution to prepare a 40% sodium perchlorate solution.

### Comparative Example 1-2

Propylene glycol mono-methyl ether (melting point of 120° C.) (10 g) was mixed with 66.7 g of a 60% sodiumperchlorate aqueous solution and then a further 23.3 g of water were admixed to prepare a 40% sodiumperchlorate solution.

TABLE 1

| | Boiling | Example | Example | Example | Example | Comp. | Comp. |
|---|---|---|---|---|---|---|---|
| | point | 1-1 | 1-2 | 1-3 | 1-4 | 1-1 | 1-2 |
| 60% aqueous | | 66.7 | 66.7 | 66.7 | 66.7 | 66.7 | 66.7 |
| solution of sodium | | | | | | | |
| perchlorate | | | | | | | |
| triethylene glycol | 249° C. | 10 | | | | | |
| mono-methyl ether | | | | | | | |
| polyethylene glycol | >250° C. | | 10 | | | | |
| 200 | | | | | | | |
| glycerine | 290° C. | | | 10 | 20 | | |
| propylene glycol | 120° C. | | | | | | 10 |
| mono-methyl ether | | | | | | | |
| water | | 23.3 | 23.3 | 23.3 | 13.3 | 33.3 | 23.3 |
| Loss in weight | | −38.1 | −37.3 | −36.4 | −26.1 | −48.9 | −41.2 |
| (%) due to | | | | | | | |
| evaporation after | | | | | | | |
| being left to stand | | | | | | | |
| for 10 days | | | | | | | |
| Day on which the | | 6th day | 6th day | 8th day | no | 3rd day* | 3rd day |
| precipitation of | | | | | precipitation | | |
| crystals was | | | | | | | |
| observed | | | | | | | |

*Almost evaporated to dryness by the 10th day

As is clear from Table 1 above, crystals precipitated out readily due to the evaporation of water with the sodium perchlorate aqueous solution (Comparative Example 1-1) and the sodium perchlorate aqueous solution to which an organic solvent of low boiling point had been added (Comparative Example 1-2) and they were dangerous to handle, but the precipitation of crystals was suppressed when a high boiling point water-soluble organic solvent was included (Example 1-1 to 1-4).

With Example 1-4 nocrystals precipitated within 10 days. The precipitation of crystals is suppressed and contamination incidents due to the scattering of crystalline material due to drying out are avoided and the material can be handled safely.

### Example 2

### Polyurethane-Lined Sheet

The stabilizer components prepared in each of the aforementioned preparative examples were added to a vinyl chloride resin composition in accordance with the formulation indicated below.

The vinyl chloride resin compositions were dried up for 1 hour at 110° C. in a Geer oven and then compounds where made by mixing for 5 minutes using a crushing machine. Sheets were made with the powder moulding technique outlined below using these compounds. A chrome mirror surface plate was heated to above 240° C. for about 15 minutes in a Geer oven at 300° C.

The plate was taken out of the Geer oven and the said compound was sprinkled on the mirror surface plate at the point in time when it reached 240° C. and quickly spread out to a uniform thickness and left to stand for 10 seconds.

The un-gelled excess compound was tipped off and then it was introduced into an electric oven at 350° C. for 15 seconds and gelled completely. The mould was taken out and cooled and a sheet was obtained.

| (formulation of compound): | parts by weight |
|---|---|
| Suspension PVC | 100 |
| Paste PVC | 15 |
| Tri-octyl trimellitate | 80 |
| ESBO (epoxidized soybean oil) | 5 |
| Beige pigment | 5 |
| Zinc stearate | 0.3 |
| Na-A-Type Zeolite | 2.0 |
| Alkamizer 7 ® | 0.5 |
| (hydrotalcite-like compound, Kyowa Chemical Industry) | |
| Dibenzoylmethane | 0.2 |
| n-octadecyl 1,3-(4′-hydroxy-3′,5′-di-t-butylphenyl)propionate | 0.3 |
| Perchlorate solution (See Table 2 below) | 1.0 |

### Polyurethane-Lined Sheet Test

The sheet obtained above was set in a mold and then a polyurethane liquid mixture of polyol (EP-3033, Mitsui Chemical Polyurethane Co., Ltd) and polyioscyanate (CR-200, Mitsui Chemical Polyurethane Co., Ltd) (weight ratio of 10:7) (see following formulation) was injected into the mold to produced a composite of PVC sheet +polyurethane foam having a thickness of 20 mm

| | parts by weight |
|---|---|
| EP-3033 | 90.00 |
| triethanol amine | 7.21 |
| water | 2.25 |
| TEDA* | 0.54 |
| CR-200 | 71.5 |

Note
*TEDA (triethylenediamine, Kantou Chemical) and triethanol amine (Kantou Chemical) are catalyst.

The resulting polyurethane-lined sheets were heated in an oven at 120° C. for 500 hours and then the stability was evaluated by observing color change Δ E. Criteria is as following:

| | |
|---|---|
| Point 10 | higher than Δ E20, dark decomposed |
| Point 0 | lower than Δ E2 |

Results are shown in Table 2.

TABLE 2

| | | Thermal ageing |
|---|---|---|
| | | properties |
| | | with PUF |
| | Perchlorate solution | lined sample |
| Example 2-1 | None | 10 |
| Example 2-2 | 40% sodium perchlorate mixed solution | |
| | (water + 10% triethylene | 3 |
| | glycol mono-methyl ether) | |
| | (Example 1-1) | |
| Example 2-3 | 40% sodium perchlorate mixed solution | |
| | (water + 10% polyethylene glycol 200) | 3 |
| | (Example 1-2) | |
| Example 2-4 | 40% Sodium perchlorate mixed solution | |
| | (water + 10% glycerine) | 3 |
| | (Example 1-3) | |
| Example 2-5 | 40% Sodium perchlorate mixed solution | |
| | (water + 20% glycerine) | 3 |
| | (Example 1-4) | |
| Comparative | 40% Sodium perchlorate aqueous solution | 3 |
| Example 2 | (Comparative Example 1-1) | |

From Table 2 above the thermal ageing properties are clearly improved by adding sodium perchlorate solution.

The effect is not lost at all even when a water-soluble organic solvent is included as part of the aqueous solution.

### Potential for Industrial Use

Colouration and deterioration in the properties of chlorine-containing resin compositions such as polyvinyl chloride or the like can be prevented and, in particular, this can be applied effectively to automobile interior decorative materials which are used stuck onto polyurethane foam.

1. A solution of perchlorate for a stabilizer of chlorine-containing resins, comprising from 1 to 60% by weight of perchlorate, from 5 to 50% by weight of water-soluble organic solvent and from 20 to 94% by weight of water.

2. The solution of perchlorate according to claim 1, in which the boiling point of the water-soluble organic solvent is higher than 150° C.

3. A method for heat-stabilizing a chlorine-containing resin composition characterized in that (a) from 0.004 to 10 parts by weight of a solution of perchlorate containing from 1 to 60% by weight of perchlorate, from 5 to50% by weight of water-soluble organic solvent and from 20 to94% by weight of water, and (b) from 0.001 to 10 parts by weight of at least one of silicate compounds represented by the following general formula (I) are added to 100 parts by weight of the chlorine-containing resin:
M(O)a nSiO₂mH₂O (I)
in which M is at least one metal selected from alkaline earth metals and aluminum, a is 1 when M is an alkaline earth metal and3/2 where M is aluminum, n is from 1 to 5, and m is any positive integer.

4. The method according to claim 3, in which from 0.05 to 10 parts by weight of hydrotalcite is further added, as (c) component, to the chlorine-containing resin composition.

5. The method according to claim 3, in which the boiling point of the water-soluble organic solvent is higher than 150° C.

6. Use of a perchlorate solution containing from 1 to 60% by weight of perchlorate, from 5 to 50% by weight of water-soluble organic solvent and from 20 to 94% by weight of water, as a stabilizer aid for heat-stabilizing chlorine-containing resin compositions.
